(19) United States
(12) Patent Application Publication
(10) Pub. No.: US 2024/0144408 A1
(43) Pub. Date: May 2, 2024

(54) PERSONALIZED INTEGRITY MODEL

(71) Applicant: Meta Platforms, Inc., Menlo Park, CA (US)

(72) Inventors: Andrew Swerdlow, San Francisco, CA (US); Shangwen Li, Los Altos, CA (US); Roger Li, Manhattan, NY (US)

(21) Appl. No.: 17/977,914

(22) Filed: Oct. 31, 2022

(51) Int. Cl. G06Q 50/26; G06Q 50/00

(52) U.S. Cl. CPC G06Q 50/265; G06Q 50/01

(57) ABSTRACT

A method may include presenting one or more instances of social networking content and receiving, from a device associated with a first user, a self-remediation request associated with the one or more instances of social networking content. The method may further include determining, based at least in part on the self-remediation request, that one or more other self-remediation requests are associated with the one or more instances of social networking content or the first user. The method may further include classifying the one or more instances of social networking content according to one or more sensitive content classifications. The method may further include determining a custom threshold user tolerance level associated with the one or more sensitive content classifications and the first user. The method may further include configuring one or more first user account settings to restrict sensitive content satisfying or exceeding the custom threshold user tolerance level.

### BACKGROUND

Conventional social networking platforms are configured to provide users with content from their social network connections (e.g., friends, followers, accounts they follow, etc.). Many social networking platforms enforce certain community standards of content, and prohibit sharing of certain types of objectionable content that violate the community standards (e.g., hate speech, violence, nudity, etc.). However, not all users have the same standard or threshold for what constitutes objectionable content, and some users may find content offensive that doesn't violate the community standards. Social networking platforms typically provide tools for users to report or block content that they find to be objectionable or offensive. However, these tools are reactive in nature, attempting to remediate unpleasant user experiences only after they occur. Even still, such remedial measures within conventional social networking platforms are typically based on platform-wide policies regarding what constitutes appropriate content. Utilizing a standardized integrity model within a social networking platform may lead to such aforementioned unpleasant or diminished user experiences. For example, a first user and a second user who belong to different demographic groups and/or are located in different geographic locations may have diverging opinions as to whether a given instance of social networking content is appropriate. It is desirable to provide users of a social networking platform with some autonomy to personalize and/or regulate what they consider appropriate content.

### BRIEF DESCRIPTION OF THE DRAWINGS

The accompanying drawings illustrate a number of examples of the present disclosure and are a part of the specification. Together with the following description, these drawings demonstrate and explain various principles of the present disclosure.

FIG. 1 is a view of an example system usable to assist with personalizing an integrity model within a social networking platform, according to some implementations.

FIG. 2 is an example system and device that is usable to implement the techniques described herein, according to some implementations.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

Much of the information and imagery consumed in today's society (e.g., news and current events, popular culture) is presented via social media. Moreover, our interests and tastes, such as the types of information and imagery we prefer to consume, are informed by certain social norms that underpin our ideals of personal integrity. However, traditional search and discovery mechanisms within social networking platforms are inadequate to accommodate these personal integrity ideals. Methods and systems of the present disclosure may overcome these deficiencies. For example, the present disclosure describes a personalized integrity protocol or model that is configured to minimize the likelihood that social networking users have diminished experiences because of being presented with social networking content they find inappropriate. A personal integrity protocol may screen from presentation to users any social networking content that exceeds a customized threshold user tolerance level. The customized threshold user tolerance level may be personalized to the individual user account or may be customized based on other accounts that share one or more similar characteristics (e.g., age, gender, geographic location, likes, dislikes, etc.). The personalized integrity protocol may be implemented within a variety of interaction surfaces throughout the social networking system, including but not limited to searches, friend suggestions, in-feed recommendations, comments, hashtag pages interactable for a user, and autocomplete results.

A social networking platform may determine various sensitive content classifications. For example, any social networking content characterized by full or partial nudity, violence, sexuality, and/or obscenity (e.g., profanity and/or other vulgarity) may be considered within the social networking platform to be “sensitive content.” Social networking content may be determined to contain sensitive content if it is classified as containing one or a combination of these different types of sensitive content. Thus, the social networking platform may be configurable to limit and/or restrict presentation of such social networking content. In some examples, limiting and/or restricting presentation of sensitive content may include limiting suggested posts and/or accounts containing the sensitive content, excluding posts and/or accounts containing the sensitive content from search results and the like. In this regard, the social networking platform may establish or otherwise determine that certain sensitive content violates a global or community threshold (e.g., community guidelines or norms). Accordingly, such sensitive content may be screened or restricted from all users of the social networking platform.

However, some social networking content—while not violative of any global or community threshold—is still objectionable to at least some users of the social networking platform. While on the other hand, some other users of the social networking platform may not find such content objectionable or inappropriate. In order to facilitate the personalized integrity protocol described herein, a social networking platform may be able to determine a likelihood that similar accounts will find social networking content objectionable or inappropriate. As used herein, the phrase “similar accounts” may describe a normalized statistical characterization of comparable account demographics (e.g., age, gender, geographic location, social media usage data such as likes and dislikes, self-remediation data, etc.) associated with the social networking platform that is used to predict a particular outcome. In other words, the social networking platform may be able to statistically predict a likelihood that a given instance of social media content will be deemed appropriate (or, conversely inappropriate) by one or more accounts of the social networking platform. Thus, the social networking platform may be able to determine a customized threshold user tolerance level that quantifies the likelihood that any given social networking content will be inappropriate for consumption by a user based on whether the user account is similar to one or more groups (i.e., cohorts) of similarly situated accounts of the social networking platform.

In some cases, the social networking platform may be configured to establish a customized threshold user tolerance level (e.g., 50%), such that social networking content that exceeds the customized threshold tolerance level (i.e., above a 50% chance to be deemed inappropriate) is restricted from presentation. In some cases, the customized threshold user tolerance level of 50% may be a default user account setting associated with all user accounts (or in some cases, all similar user accounts). In at least some cases, the social networking platform of the present disclosure may establish a customized threshold user tolerance level for a given interaction surface. In other words, differing interaction surfaces may be configured with differing customized threshold user tolerance levels. In still some other cases, the social networking platform of the present disclosure is further configured to establish higher or lower custom threshold user tolerance levels. For example, the social networking platform may be configured to establish a custom threshold user tolerance level of at or near 25%, signifying that an instance of social networking content is more than likely (i.e., a 75% chance) to be deemed inappropriate by a given cohort of similarly situated accounts. Accordingly, the social networking platform of such examples may be configured, by default, to screen instances of sensitive social networking content from presentation until one or more user account settings are changed. In still some other cases, the social networking system of the present disclosure may be configured to determine a custom threshold user tolerance level of at or near 75%, signifying that an instance of social networking content is less than likely (i.e., a 25% chance) to be deemed inappropriate.

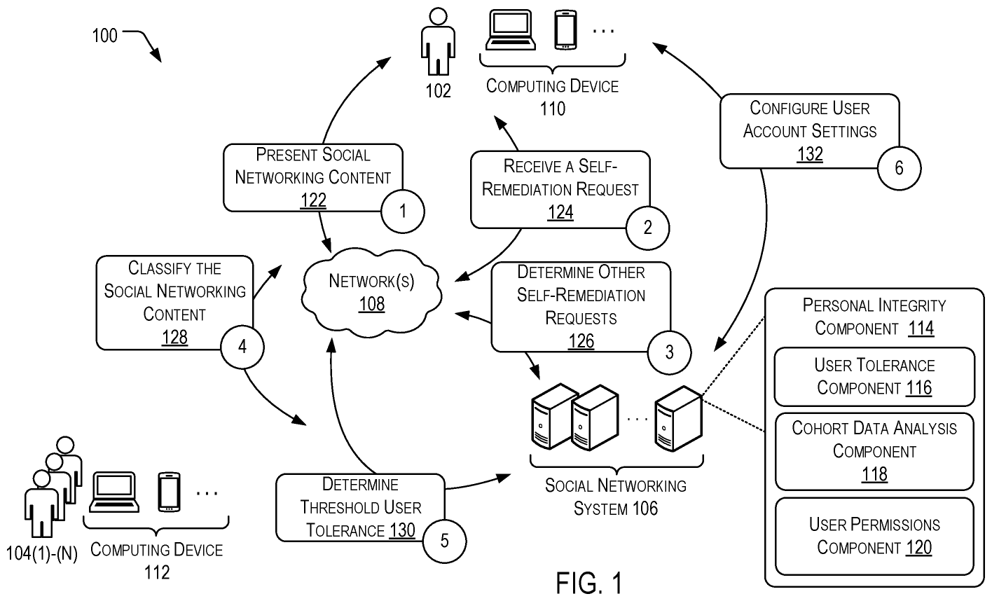

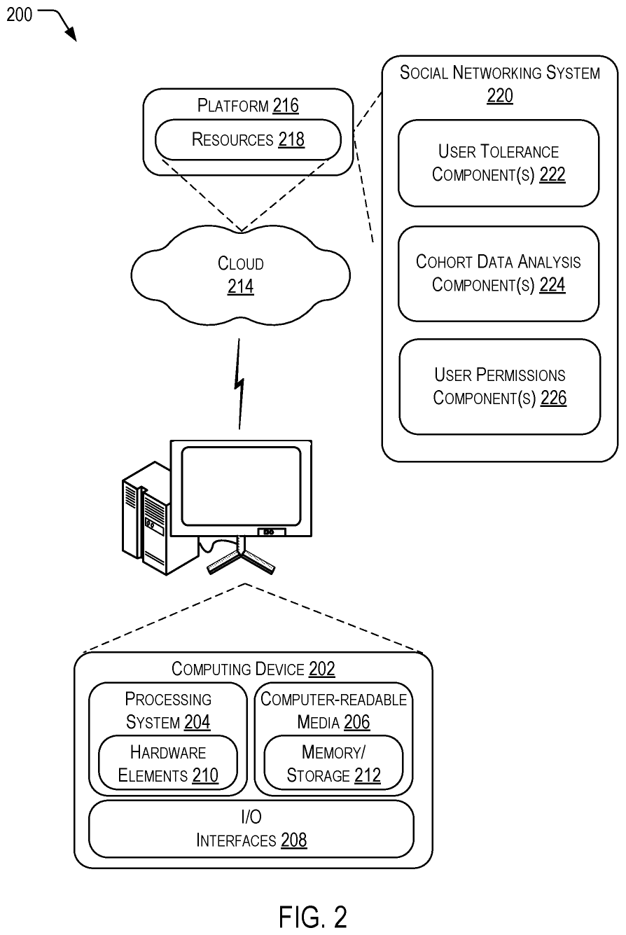

The following will provide, with reference to FIGS. 1 and 2, detailed descriptions of methods and systems for personalized integrity within a social networking platform.

FIG. 1 is a view of an example system 100 usable to assist with facilitating personalized integrity according to some implementations. In some examples, the system 100 may include a user 102 (who may be of moderate sensibilities), as well as other similar users 104(1)-104(N) (collectively “users 104”), being used to determine a custom threshold user tolerance level. The system 100 may be used to determine a custom threshold user tolerance level for the user 102 and/or the other users 104. The user 102 and users 104 may interact with a social networking system 106 via a network 108 using computing devices, generally indicated by 110 and 112, respectively.

In the illustrated example, the social networking system 106 may include a personal integrity component 114. The personal integrity component 114 may include a number of sub-components or modules, such as user tolerance component 116, cohort data analysis component 118, and user permissions component 120. The user tolerance component 116 may be configured to analyze social networking content (e.g., posts, messages, searches, etc.) to determine a statistical likelihood that an instance of social networking content is inappropriate. The cohort data analysis component 118 may be configured to receive and analyze user data relating to a plurality of social networking users to identify statistically similar users or “cohorts.” The cohort data analysis component 118 may be configured to perform statistical analysis using any appropriate cohort analysis scheme, including but not limited to time-based cohort analysis, size-based cohort analysis, segment-based cohort analysis, and the like. For example, in just one non-limiting illustration, a time-based cohort analysis may consider users who tend to “flag” or otherwise report as inappropriate content within a first threshold time period of consuming the content. The user permissions component 120 may be configured to provide functionality to search or otherwise discover sensitive content within or below a personalized tolerance level as regards the user 102 or users 104.

With respect to FIG. 1, the user 102 may be, for example, a social networking user of moderate sensibilities (e.g., based on age and other demographics, geographic location, social networking usage data, and the like). Thus, in the illustrated example, at operation 122 (indicated by the numeral “1”), the social networking system 106 may present one or more instances of social networking content at least some of which may be considered by the user 102 to be “inappropriate.” In some other examples, however, the user 102 (and, likewise the similar users 104) may be of immoderate sensibilities (e.g., based on age and other demographics, geographic location, social networking usage data, and the like). In such other examples, the user 102 and users 104 may therefore find the one or more instances of social networking content presented at operation 122 to be “appropriate.”

In the illustrated example, at operation 124, (indicated by the numeral “2”), the social networking system 106 (e.g., one or more of the user tolerance component 116 or the cohort data analysis component 118) may receive a self-remediation request in response to presenting to the user 102 the one or more instances of social networking content. In some examples, the self-remediation request may include any one or more of a report of a particular content item as violative of the community guidelines, a request to remove as a follower an account associated with the one or more instances of social networking content, a request to unfollow the posting user, a request to block the posting user, or a request to restrict the posting user.

In the illustrated example, at operation 126, (indicated by the numeral “3”), the social networking system 106 (e.g., one or more of the user tolerance component 116 or the cohort data analysis component 118) may determine that other self-remediation requests are associated with the one or more instances of social networking content that were presented to user 102 at operation 122. In some examples, the other self-remediation requests may include one or more subsequent or prior self-remediation requests submitted by the user 102. In some other cases, the other self-remediation requests may include one or more subsequent or prior self-remediation requests submitted by one or more other, similar users, such as one of the users 104.

At operation 128 (indicated by the numeral “4”), the social networking system 106 (e.g., one or more of the user tolerance component 116 or the cohort data analysis component 118) may classify the one or more instances of social networking content according to one or more sensitive content classifications. For example, a machine learning algorithm may be trained to detect sound events in an audio signal, and combine or aggregate the classifications of individual sound events. In some examples, a machine learning algorithm may also classify video content, such as, based on multiple dimensions (e.g., x- and y-dimensions) present in individual frames. In this way, a machine learning algorithm may be trained to determine what is “happening” in social networking content (i.e., to determine whether the content is characterized by one or more sensitive content classifications.

Next, at operation 130 (indicated by the numeral “5”), the social networking system 106 (e.g., one or more of the user tolerance component 116 or the cohort data analysis component 118) may determine a custom threshold user tolerance level. In some cases, the social networking system 106 may implement a machine learning algorithm trained to predict a custom threshold user tolerance level. For example, the social networking system 106 (e.g., one or more of the user tolerance component 116 or the cohort data analysis component 118) may be configured to implement one or more cohort analysis algorithms, such as retention analysis, to analyze similar users in order to predict the custom threshold user tolerance level. For example, the account belonging to the user 102 may statistically be “grouped” with similar accounts according to one or more appropriate characteristics such as age, geographic location, user behavior or the like. In at least some cases, to prevent or overcome unintended bias, the social networking system may be configured to implement one or more weighted cohort analyses. In this way, individual characteristics may be weighted according to certain sampling probabilities. In at least some examples, user behavior at least including “following,” “unfollowing,” or “restricting” may be modeled under a retention analysis framework.

At operation 132 (indicated by the numeral “6”), the social networking system 106 (i.e., the user permissions component 120) may configure one or more user account settings based on the custom threshold user tolerance level determined at operation 130. For example, the social networking system 106 may configure one or more user account settings to screen social networking content satisfying or exceeding the custom threshold user tolerance associated with user 102.

In the illustrated example, each of the computing devices 110 and 112 may include one or more processors and memory storing computer executable instructions to implement the functionality discussed herein attributable to the various computing devices. In some examples, the computing devices 110 and 112 may include desktop computers, laptop computers, tablet computers, mobile devices (e.g., smart phones or other cellular or mobile phones, mobile gaming devices, portable media devices, etc.), or other suitable computing devices. The computing devices 110 and 112 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 110 and 112 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable the user 102 and users 104 (such as persons or organizations) to interact with the social networking system 106 and with each other via the computing devices 110 and 112. The social networking system 106 may, with input from a user, create and store in the social networking system 106 a user account associated with the user. The user account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users.

In some examples, the social networking system 106 may provide privacy features to the users 102 and 104 while interacting with the social networking system 106. In particular examples, one or more objects (e.g., content or other types of objects) of the social networking system 106 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a user, such as a user 102 and 104, may share an object to the social networking system 106. The object may be associated with a concept node connected to a user node of the user 102 and/or 104 by an edge. The user 102 and/or 104 may specify privacy settings that apply to a particular edge connecting to the concept node of the object or may specify privacy settings that apply to all edges connecting to the concept node. In some examples, the user 102 and/or 104 may share a set of objects of a particular object-type (e.g., a set of images). The user 102 and/or 104 may specify privacy settings with respect to all objects associated with the user 102 and/or 104 of that particular object-type as having a particular privacy setting (e.g., specifying that all images posted by the user 102 and/or 104 are visible only to friends of the user and/or users tagged in the images).

In particular examples, the social networking system 106 may present a “privacy wizard” (e.g., within a webpage, a module, one or more dialog boxes, or any other suitable interface) to the user 102 and/or 104 to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102 and/or 104 that may display, to the user 102 and/or 104, current privacy settings of the user 102 and/or 104. The dashboard functionality may be displayed to the user 102 and/or 104 at any appropriate time (e.g., following an input from the user 102 and/or 104 summoning the dashboard functionality, following the occurrence of a particular event or trigger action). The dashboard functionality may allow the user 102 and/or 104 to modify one or more of the user's current privacy settings at any time, in any suitable manner (e.g., redirecting the user 102 and/or 104 to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102 and/or 104 (or other entity) for a particular object stored in a data store, the social networking system 106 may send a request to the data store for the object. The request may identify the user 102 and/or 104 associated with the request and the object may be sent only to the user 102 and/or 104 (or a client system of the user) if the authorization server determines that the user 102 is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example, and not by way of limitation, one or more objects may be visible to a user's “Trending” page. In particular examples, an object may correspond to a particular user. The object may be content associated with the particular user, or may be the particular user's account or information stored on the social networking system 106, or other computing systems. As an example, and not by way of limitation, the user 102 and/or 104 may view one or more other users 102 and/or 104 of an online social network through a “People You May Know” function of the online social network, or by viewing a list of friends of the user 102. As an example, and not by way of limitation, the user 102 and/or 104 may specify that they do not wish to see objects associated with a particular other user (e.g., the user 102 and/or 104) in their newsfeed or friends list. If the privacy settings for the object do not allow it to be surfaced to, discovered by, or visible to the user 102 and/or 104, the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example, and not by way of limitation, the user 102 and/or 104 may specify that the user's status updates are public, but any images shared by the user are visible only to the user's friends on the online social network. In some examples, the user 102 and/or 104 may specify different privacy settings for different types of entities, such as individual users, friends-of-friends, followers, user groups, or corporate entities. In some examples, the user 102 and/or 104 may specify a group of users that may view videos posted by the user 102 and/or 104, while keeping the videos from being visible to the user's employer. In particular examples, different privacy settings may be provided for different user groups or user demographics. As an example, and not by way of limitation, the user 102 and/or 104 may specify that other users who attend the same university as the user 102 and/or 104 may view the user's pictures, but that other users who are family members of the user 102 and/or 104 may not view those same pictures.

In particular examples, the social networking system 106 may provide one or more default privacy settings for each object of a particular object-type. A privacy setting for an object that is set to a default may be changed by a user associated with that object. As an example, and not by way of limitation, all images posted by the user 102 and/or 104 may have a default privacy setting of being visible only to friends of the first user and, for a particular image, the user 102 and/or 104 may change the privacy setting for the image to be visible to friends and friends-of-friends.

In particular examples, privacy settings may allow the user 102 and/or 104 to specify (e.g., by opting out, by not opting in) whether the social networking system 106 may receive, collect, log, or store particular objects or information associated with the user 102 and/or 104 for any purpose. In particular examples, privacy settings may allow the user 102 and/or 104 to specify whether particular applications or processes may access, store, or use particular objects or information associated with the user. The privacy settings may allow the user 102 and/or 104 to opt in or opt out of having objects or information accessed, stored, or used by specific applications or processes. The social networking system 106 may access such information in order to provide a particular function or service to the user 102 and/or 104, without the social networking system 106 having access to that information for any other purposes. Before accessing, storing, or using such objects or information, the social networking system 106 may prompt the user 102 and/or 104 to provide privacy settings specifying which applications or processes, if any, may access, store, or use the object or information prior to allowing any such action. As an example, and not by way of limitation, the user 102 and/or 104 may transmit a message to the user 102 and/or 104 via an application related to the online social network (e.g., a messaging app), and may specify privacy settings that such messages should not be stored by the social networking system 106.

In particular examples, the user 102 and/or 104 may specify whether particular types of objects or information associated with the user 102 and/or 104 may be accessed, stored, or used by the social networking system 106. As an example, and not by way of limitation, the user 102 and/or 104 may specify that images sent by the user 102 and/or 104 through the social networking system 106 may not be stored by the social networking system 106. In some examples, the user 102 and/or 104 may specify that messages sent from the user 102 and/or 104 to another user may not be stored by the social networking system 106. In some cases, the user 102 and/or 104 may specify that all objects sent via a particular application may be saved by the social networking system 106.

In particular examples, privacy settings may allow the user 102 and/or 104 to specify whether particular objects or information associated with the user 102 and/or 104 may be accessed from particular client systems or third-party systems. The privacy settings may allow the user 102 and/or 104 to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102 and/or 104 may be prompted to specify a particular privacy setting for each context. As an example, and not by way of limitation, the user 102 and/or 104 may utilize a location-services feature of the social networking system 106 to provide recommendations for restaurants or other places in proximity to the user 102 and/or 104. The default privacy settings of the user 102 and/or 104 may specify that the social networking system 106 may use location information provided from the computing device 110 and/or 112 of the user 102 and/or 104 to provide the location-based services, but that the social networking system 106 may not store the location information of the user 102 and/or 104 or provide it to any third-party systems. The user 102 and/or 104 may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, a user may specify that a particular image uploaded by the user is visible to the user's friends for the next week, after which time the image may no longer be accessible to other users. In some examples, a company may post content related to a product release ahead of the official launch and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example, and not by way of limitation, the user 102 may transmit a message to the user 104, and the social networking system 106 may temporarily store the message in a data store until the user 104 has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example, and not by way of limitation, the user 102 may share a first image and specify that the first image is to be public to all other users. At a later time, the user 102 and/or 104 may specify that any images shared by the user should be made visible only to a first user group. The social networking system 106 may determine that this privacy setting also applies to the first image and make the first image visible only to the first user group. In particular examples, the change in privacy settings may take effect only going forward. Continuing the example above, if the user 102 and/or 104 changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user's change to privacy may be a global change for all objects associated with the user.

In particular examples, the social networking system 106 may determine that user 102 and/or 104 may want to change one or more privacy settings in response to a trigger action associated with the user 102 and/or 104. The trigger action may be any suitable action on the online social network. As an example, and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102 and/or 104 to change the privacy settings regarding the visibility of objects associated with the user 102 and/or 104. The prompt may redirect the user 102 and/or 104 to a workflow process for editing privacy settings with respect to one or more entities associated with the trigger action. The privacy settings associated with the user 102 and/or 104 may be changed only in response to an explicit input from the user 102 and/or 104 and may not be changed without the approval of the user 102 and/or 104. As an example, and not by way of limitation, the workflow process may include providing the user 102 with the current privacy settings with respect to the user 104 or to a group of users (e.g., un-tagging the user 102 or the user 104 from particular objects, changing the visibility of particular objects with respect to the user 104 or a group of users), and receiving an indication from the user 102 to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example, and not by way of limitation, the social networking system 106 may send a reminder to the user to confirm his or her privacy settings every six months or after every ten photo posts. In particular examples, privacy settings may also allow users to control access to the objects or information on a per-request basis. As an example, and not by way of limitation, the social networking system 106 may notify the user whenever a third-party system attempts to access information associated with the user and require the user to provide verification that access should be allowed before proceeding.

FIG. 2 illustrates an example system 200 that includes an example computing device 202 that is representative of one or more computing systems and/or devices that may implement the various techniques described herein. This is illustrated through inclusion of a social networking system 220, which may be similar to social networking system 106 of FIG. 1. The illustrated social networking system 220 comprises a user tolerance component 222, a cohort data analysis component 224, and a user permissions component 226. The user tolerance component 222, cohort data analysis component 224, and user permissions component 226 may each be similar, respectively, to the user tolerance component 116, the cohort data analysis component 118, and the user permissions component 120 of FIG. 1.

The computing device 202 may be, for example, a server of a service provider, a device associated with a client (e.g., a client device), an on-chip system, and/or any other suitable computing device or computing system. The example computing device 202 as illustrated includes a processing system 204, one or more computer-readable media 206, and one or more input/output interfaces 208 that are communicatively coupled, one to another. Although not shown, the computing device 202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 204 is representative of functionality to perform one or more operations using hardware. Accordingly, the processing system 204 is illustrated as including hardware elements 210 that may be configured as processors, functional blocks, and so forth. This may include implementation in hardware as an application specific integrated circuit or other logic device formed using one or more semiconductors. The hardware elements 210 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 206 is illustrated as including memory/storage 212. The memory/storage 212 represents memory/storage capacity associated with one or more computer-readable media. The memory/storage 212 may include volatile media (such as random access memory (RAM)) and/or nonvolatile media (such as read only memory (ROM), Flash memory, optical disks, magnetic disks, and so forth). The memory/storage 212 may include fixed media (e.g., RAM, ROM, a fixed hard drive, and so on) as well as removable media (e.g., Flash memory, a removable hard drive, an optical disc, and so forth). The computer-readable media 206 may be configured in a variety of other ways as further described below.

Input/output interface(s) 208 are representative of functionality to allow a user to enter commands and information to computing device 202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 202. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 202, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 210 and computer-readable media 206 are representative of modules, programmable device logic and/or device logic implemented in a hardware form that may be employed to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 210. The computing device 202 may be configured to implement particular instructions and/or functions corresponding to the software and/or hardware modules. Accordingly, implementation of a module that is executable by the computing device 202 as software may be achieved at least partially in hardware, e.g., through use of computer-readable storage media and/or hardware elements 210 of the processing system 204. The instructions and/or functions may be executable/operable by one or more articles of manufacture (for example, one or more computing devices 202 and/or processing systems 204) to implement techniques, modules, and examples described herein.

The techniques described herein may be supported by various configurations of the computing device 202 and are not limited to the specific examples of the techniques described herein. This functionality may also be implemented all or in part through use of a distributed system, such as over a computing environment or “cloud” 214 via a platform 216 as described below.

The cloud 214 includes and/or is representative of a platform 216 for resources 218. The platform 216 abstracts underlying functionality of hardware (e.g., servers) and software resources of the cloud 214. The resources 218 may include applications and/or data that can be utilized while computer processing is executed on servers that are remote from the computing device 202. Resources 218 can also include services provided over the Internet and/or through a subscriber network, such as a cellular or Wi-Fi network.

The platform 216 may abstract resources and functions to connect the computing device 202 with other computing devices. The platform 216 may also be scalable to provide a corresponding level of scale to encountered demand for the resources 218 that are implemented via the platform 216. Accordingly, in an interconnected device as described in the present disclosure, implementation of functionality described herein may be distributed throughout multiple devices of the system 200. For example, the functionality may be implemented in part on the computing device 202 as well as via the platform 216 which may represent a cloud computing environment.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the present disclosure. This example description is not intended to be exhaustive or to be limited to any precise form disclosed. Many modifications and variations are possible without departing from the spirit and scope of the present disclosure. The present disclosure should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for inferring an individual tolerance for social networking content comprising:
presenting one or more instances of social networking content;
receiving, from a device associated with a first user, a self-remediation request associated with the one or more instances of social networking content;
determining, based at least in part on the self-remediation request, that one or more other self-remediation requests are associated with the one or more instances of social networking content or the first user;
classifying the one or more instances of social networking content according to one or more sensitive content classifications;
determining a custom threshold user tolerance level associated with the one or more sensitive content classifications and the first user; and
configuring one or more first user account settings to screen sensitive content satisfying or exceeding the custom threshold user tolerance level.

2. The computer-implemented method of claim 1, wherein the one or more sensitive content classifications include one or more of nudity, violence, sexuality, and obscenity.

3. The computer-implemented method of claim 1, wherein determining the custom threshold user tolerance level comprises:
determining an acceptable probability of being deemed as either inappropriate or appropriate by the first user or one or more other similar users.

4. The computer-implemented method of claim 1, wherein screening sensitive content satisfying or exceeding the custom threshold user tolerance level comprises one or more of filtering content, down ranking, or providing a warning prior to presenting the sensitive content.
